(19) United States
(12) Patent Application Publication
(10) Pub. No.: US 2014/0070537 A1
(43) Pub. Date: Mar. 13, 2014

(54) WIND TURBINE

(71) Applicants: Jurgen Stoltenjohannes, Aurich (DE); Albrecht Brenner, Aurich (DE)

(72) Inventors: Jurgen Stoltenjohannes, Aurich (DE); Albrecht Brenner, Aurich (DE)

(73) Assignee: WOBBEN PROPERTIES GMBH, Aurich (DE)

(21) Appl. No.: 14/007,258

(22) PCT Filed: Mar. 30, 2012
(86) PCT No.: PCT/EP2012/055780

§ 371 Date: Nov. 26, 2013

(30) Foreign Application Priority Data
Apr. 1, 2011 (DE) 10 2011 006 635.7

(51) Int. Cl. G01M 15/14; F03D 7/02

(52) U.S. Cl. CPC G01M 15/14; F03D 7/02
USPC 290/44; 73/112.01

(57) ABSTRACT

There is provided a wind power installation having a component to be monitored and a crack detection unit. In that case the crack detection unit has at least one thread or fiber which is fastened directly on the component to be monitored. The crack detection unit further has a crack detector which serves to detect whether the thread or fiber is or is not cracked.

### BACKGROUND

1. Technical Field

The present invention concerns a wind power installation.

2. Description of the Related Art

Wind power installations convert the kinetic energy of the wind into electric energy. In that case the wind power installations are exposed to “wind and weather”, which leads to considerable loadings on the wind power installation and parts thereof. The stresses or loadings for the parts or components of the wind power installation can be very different. It is however necessary to ensure that the corresponding parts can withstand the loadings to be expected. In addition it is important to detect possible damage to the wind power installation as early as possible.

### BRIEF SUMMARY

One or more embodiments of the present invention is to provide a wind power installation which affords a simple and inexpensive possibility of quickly and reliably detecting damage to the wind power installation.

Thus there is provided a wind power installation having a component to be monitored and a crack detection unit for detecting a crack in the component. In that case the crack detection unit has at least one thread or fiber which is fastened directly on an inner or outer surface or embedded in the component to be monitored. The crack detection unit further has a crack detector which serves to detect whether the thread or fiber is or is not cracked or torn.

By virtue of direct fastening of the thread or fiber on or in the component to be monitored a crack in the component also leads directly to a crack in the thread. That crack can then be detected by the crack detector and control of the wind power installation can be suitably influenced.

In an aspect of the invention the wind power installation has a control unit for controlling operation of the wind power installation. If the crack detector detects that the thread or fiber is cracked then the control unit can influence operation of the wind power installation. Such influence could provide for example that the mechanical loading on the monitored component is reduced (for example by reducing the rotary speed, changing the pitch angle, altering the azimuth position and so forth).

In a further aspect of the invention the thread or fiber can be made from one or more materials that are electrically conducting or light-conducting. In that way crack detection can be effected either by electric or by optical checking.

In an aspect of the invention the fiber can be in the form of a glass fiber or a carbon fiber. In the case of a glass fiber optical checking can be effected and in the case of a carbon fiber electric checking can be effected.

In a further aspect of the invention it is possible to provide fibers or threads of differing lengths to permit the position of the crack to be more accurately determined. The fibers or threads can be straight, of a meander configuration or of a grid structure.

The invention also concerns a method of monitoring components of a wind power installation. For that purpose threads or fibers are fastened directly on or in the component to be monitored. Then a crack detector is used to detect whether the thread or fiber is or is not cracked.

The invention concerns the notion of providing a wind power installation which involves simple and effective crack detection on components of the wind power installation. Cracks occurring at crack-endangered locations of the wind power installation (for example rotor blades, castings, pylon, foundation and so forth) can be detected by means of crack detection. To implement crack detection, an interruptible thread or fiber is fastened, for example by adhesive, to the locations to be monitored (crack-endangered locations), or the thread or fiber is fitted in the component to be monitored. If a crack occurs at the respective component then that will also lead to an interruption in the thread of the crack detection system. That crack or the interruption in the thread or fiber can then be detected for example electrically or optically. If a crack in the fiber is detected that can result in the control system of the wind power installation being influenced, for example to reduce the mechanical loading on the cracked component. A reduction in the mechanical loading on the installation can be effected for example by control of the pitch angle of rotor blades or by control of the azimuth drive.

The interruptible thread or fiber can be for example a light conductor, an optical waveguide, an electric conductor, a glass fiber, a carbon fiber or the like. The interruption in the thread can be detected for example electrically or by means of light. After an interruption has been detected the control system of the wind power installation can be influenced and the installation can possibly be stopped.

The crack detection or crack monitoring system according to one embodiment of the invention can afford crack detection at an early stage so that suitable countermeasures (adapted control of the wind power installation or replacement of the cracked component) can be taken before really major damage can occur.

According to one embodiment of the invention the thread can be fastened in a plurality of passes, in a meander shape and/or in the form of a grid structure, on the component to be monitored (such as for example a rotor blade, a steel rotor blade, a GRP rotor blade, a CRP rotor blade, castings of the installation (such as for example the rotor hub), a concrete or steel pylon or the foundation).

Preferably the threads or fibers are fastened flat on one or more surfaces of the component to be monitored (in particular by adhesive). Gluing the threads or fibers in position flat on the component is advantageous as a crack can thus be relatively quickly detected. In particular it is possible thereby to avoid the thread or fiber stretching too long before it tears away.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawings.

FIG. 1 shows a diagrammatic view of a wind power installation according to an embodiment of the invention,

FIGS. 2A and 2B show diagrammatic views of a rotor blade with a crack detection unit according to embodiments of the invention,

FIGS. 3A and 3B each show a diagrammatic view of a pylon of a wind power installation having a crack detection unit according to embodiments of the invention, and

FIG. 4 shows a diagrammatic view of a part of a rotor blade of a wind power installation together with a crack detection unit.

### DETAILED DESCRIPTION

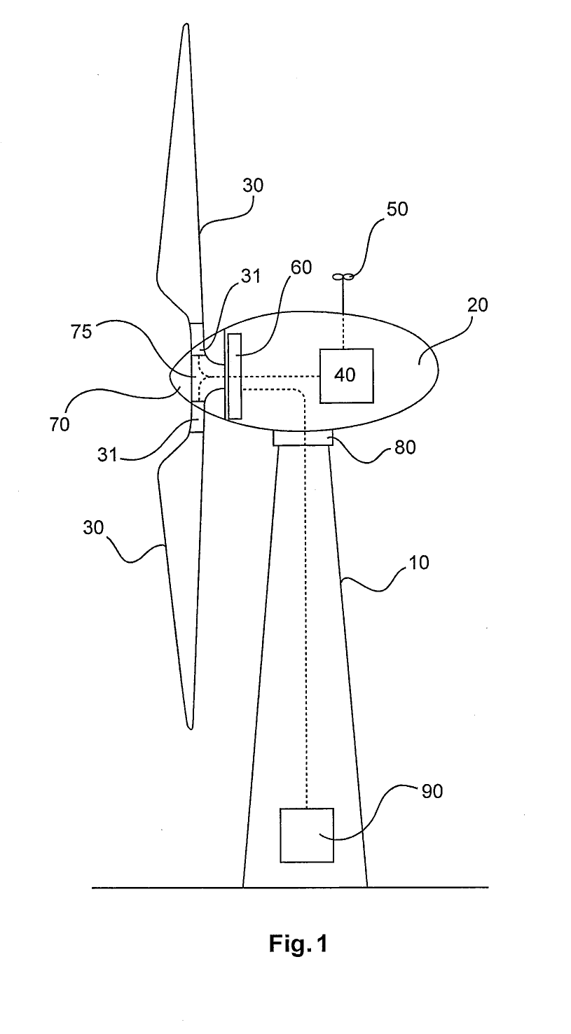

FIG. 1 shows a diagrammatic view of a wind power installation according to the invention. The wind power installation has a pylon 10 and a pod 20 on the pylon 10. Azimuthal orientation of the pod can be altered by means of an azimuth drive 80 to adapt the orientation of the pod to the currently prevailing wind direction. The pod 20 has a rotatable rotor 70 with at least two and preferably three rotor blades 30. The rotor blades 30 can be connected to a rotor hub 75 which in turn is connected to an electric generator 60 directly or by means of a gear arrangement (not shown). The rotor of the generator 60 is rotated by rotation of the rotor blades 30 and of the rotor 70 and that therefore provides for the generation of electric energy.

The wind power installation further has a control unit 40 for controlling operation of the wind power installation. In addition an anemometer and/or a wind direction indictor 50 can be provided on the pod 20. The control unit 40 can adjust the pitch angle of the rotor blades 30 by means of pitch drives 31. In addition the control unit 40 can control the azimuthal orientation of the pod by means of the azimuth drive 80. The electric energy generated by the generator 60 is passed to a power cabinet 90 for example in the base of the pylon 10. A converter can be provided in the power cabinet 90, and can deliver the electric power at a desired voltage and frequency to an energy supply network.

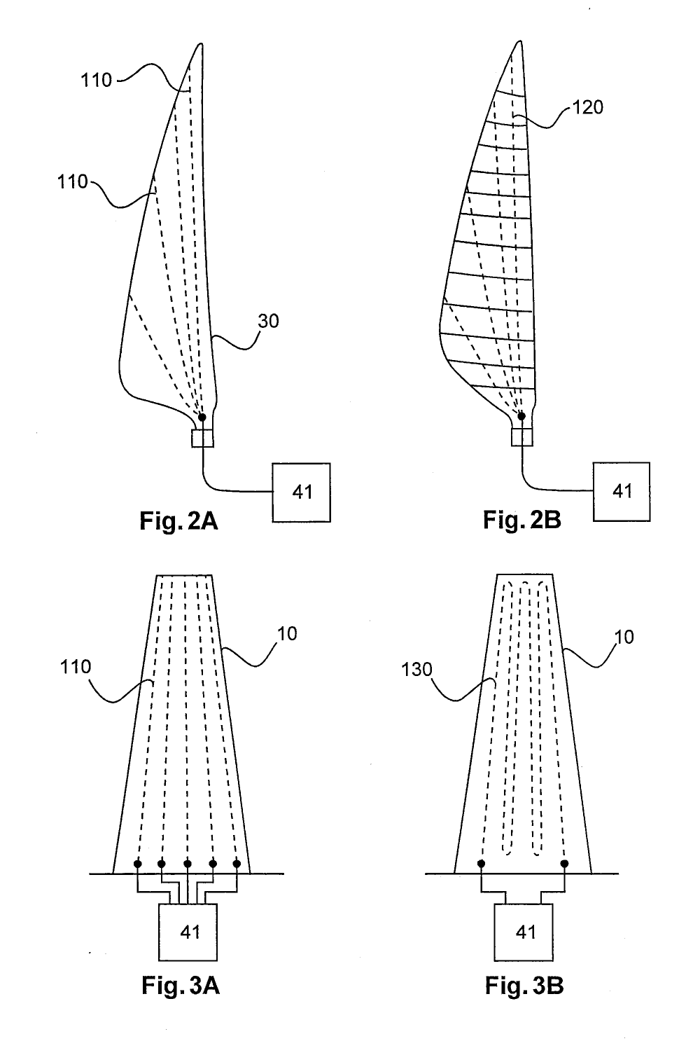

FIG. 2A shows a diagrammatic view of a rotor blade 30 of the wind power installation of FIG. 1 together with a crack detection unit according to one embodiment. In this case the crack detection unit comprises at least one (interruptible) thread or fiber 110 provided in the rotor blade on the inside (or alternatively or additionally on the outside). That thread or fiber 110 is preferably glued to the inside surface of the rotor blade or fixed thereon in some other fashion. In one embodiment, the thread or fiber 110 is secured in a flat manner across a surface of the rotor blade. The thread 110 is an interruptible thread. If the material of the rotor blade 30 cracks then the thread or the fiber will also crack or tear. That is, as the material of the rotor blade 30 separates along a crack, the thread or fiber is also pulled apart. The thread or fiber may be suitably brittle to break apart in response to a particular sized crack to be monitored on the rotor blade. The interruption in the thread 110 in the case of a crack in the material of the rotor blade can be detected by a crack detector 41. Detection of a crack or tear in the fiber 110 can be effected for example electrically or optically. In the case of electric detection, the thread 110 includes electrically conductive material. In the case of optical detection, the thread 110 is capable of conducting light.

As will be clear to those of ordinary skill in the art, if electrical detection is used, the crack detector 41 may include an electronic device that is electrically coupled to the thread or fiber and configured to receive an electrical signal from the thread or fiber 110. If the thread or fiber breaks apart due to a crack in the rotor blade 30, the electrical signal received by the electronic device will be different than it was prior to the thread or fiber 110 breaking. For instance, after the thread or fiber 110 breaks, a current or voltage received by the electronic device may be zero. If optical detection is used, the crack detector 41 may include an optical device that is optically aligned with thread or fiber and configured to receive an optical signal therefrom. If the thread or fiber breaks apart due to a crack in the rotor blade 30, the optical signal received by the optical device changes.

The crack detector 41 can be part of the control unit 40 or can be connected thereto according to another embodiment of the invention. Upon detection of a crack, the control unit 40 can influence operation of the wind power installation (adjustment of the pitch angles, adjustment of the azimuth angle and so forth). In particular such influence can lead to a reduction in the mechanical loading on the rotor blade or also on other parts of the wind power installation to suitably protect the components.

FIG. 2B shows a diagrammatic view of a rotor blade on the wind power installation of FIG. 1 with a crack detection unit. Threads 120 are provided within the rotor blade or at the inside surface of the rotor blade. In this case the threads are arranged in a grid structure while the threads 111 in FIG. 2A are oriented substantially in the longitudinal direction or in one direction. The advantage of a grid structure is that the precise position of the crack in the rotor blade can be better detected. The functioning of the crack detector 41 corresponds to that of the crack detector 41 in FIG. 2A.

Optionally the threads or fibers shown in FIG. 2A and FIG. 2B can also have a return line back to the detector 41.

FIG. 3A shows a diagrammatic view of a pylon 10 of a wind power installation of FIG. 1 with a crack detection unit according to an embodiment of the invention. Provided at the inside surface of the pylon 10 is at least one thread (or fiber), preferably a plurality of threads (or fibers) 110, in particular in one direction. The threads 110 are preferably glued or fastened in some way to the inside surface of the pylon (steel or concrete). If a crack occurs in the steel or concrete of the pylon then that crack will cause a crack or tear in one of the threads 110. That crack or tear can be detected by the crack detector 41.

Optionally the crack detection unit of FIG. 3A can have threads or fibers which extend back to the detection unit 41 by way of a return line.

FIG. 3B shows a diagrammatic view of a pylon 10 of a wind power installation of FIG. 1 with a crack detection unit according to another embodiment of the invention. The crack detection unit 100 has at least one thread 130 at the inside surface of the pylon 10. In this embodiment, the thread 130 can be fastened to the inside surface of the pylon 10 in a meander shape. The thread 130 is coupled to a crack detector 41. The functioning of the crack detector 41 corresponds in that respect to that of the crack detector in FIG. 2A.

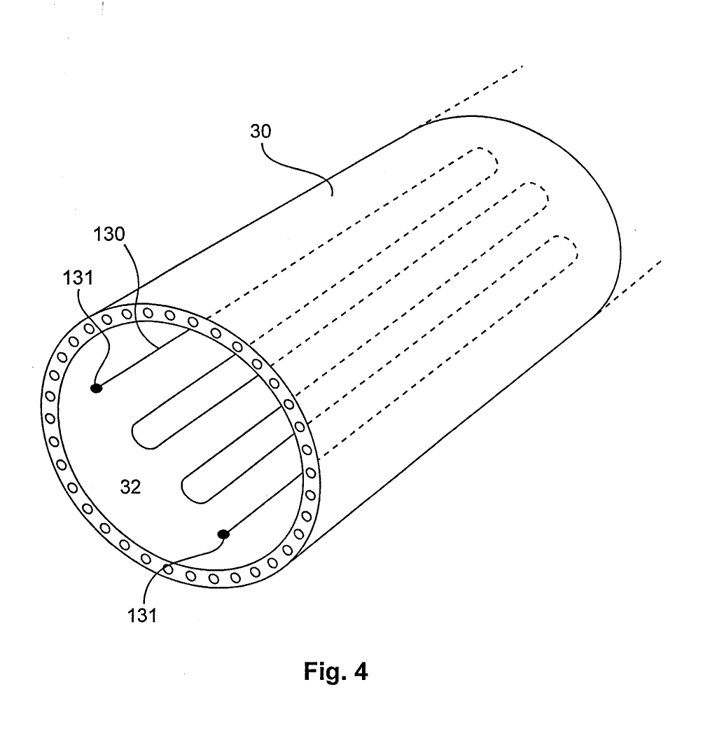

FIG. 4 shows a diagrammatic view of a part of a rotor blade of the wind power installation of FIG. 1 according to one embodiment of the invention. A thread or fiber 130 is provided in a meander shape at the inside surface 32 of the rotor blade 30. The thread or fiber can be glued to the inside of the rotor blade. If a crack in the material of the rotor blade occurs, that will also lead to a crack or tear in the thread or fiber 130. Such a crack or tear can be detected by a crack detector 41 (not shown) as already described hereinbefore.

The crack detection unit according to the invention can also be provided for example on the rotor hub 75.

The crack detection unit according to the invention can be used in relation to all components of a wind power installation which is crack-endangered. For that purpose it is only necessary for threads or fibers of the crack detection unit to be fastened (for example glued) on surfaces of components to be monitored.

The thread or fibers for crack detection can be fastened or glued on the component to be monitored, in point form or in flat areal relationship. Fastening of the thread or fiber to the component to be monitored must be such that, if a crack occurs in the component to be monitored, that also leads to a crack or tear in the thread or fiber so that the crack in the component can be suitably detected.

In a further embodiment which can be based on the preceding embodiments, the threads or fibers can be fitted or fastened in the component to be monitored. That can be effected for example when casting the foundation. As an alternative thereto the fibers or threads can be provided for example between glass fiber mats upon production of a rotor blade.

Detection of the exact crack or tear location on the thread or fiber is possible for example if the spacing of the tear location from the beginning of the thread or fiber can be determined by a reflection method. If the thread or fiber is for example electrically conducting, it is then possible to use reflection methods involving remote signaling technology.

If the threads or fibers are glass fiber threads or fibers then a fault location can be determined to a precision of a few centimeters by means of the backscatter method. For that purpose a so-called optical time division reflectometer OTDR can be used. Such monitoring can be effected continuously by an optical switching device during operation of the wind power installation. As an alternative thereto the optical time division reflectometer can also be in the form of a portable device so that a service team can perform the monitoring procedure.

If the threads or fibers have a return line then a change in damping can be detected by means thereof. One reason for a change in damping can represent for example a crack.

Locating a crack can also be effected for example in the peripheral direction in the case of a meander-shape configuration for the detector if the meanders are distributed in the peripheral direction.

In FIGS. 2A, 2B and 3A the end remote from the detector 41 can be connected to earth so that crack detection can be effected.

The embodiments for crack detection shown in FIGS. 2A, 2B and 3A can be advantageous when permanent length monitoring is effected. That can optionally also be effected when the threads or fibers are disposed in or fastened in the component to be monitored (cast or laid internally therein, for example between glass fiber mats). Crack detection can respond upon an abrupt reduction in the line length.

As an alternative thereto length monitoring can be successful when the thread or fiber has a return line back to the detector. That return line to the detector can also be glued on the surface of the rotor blade or fastened thereto in areal relationship and can also be used for crack detection.

The crack detection unit according to the invention can be used in relation to all components of a wind power installation, which are at risk of cracking. In that respect the components can represent for example the foundation of the wind power installation, the pylon of the wind power installation (particularly in the case of a concrete pylon), all cast parts of the wind power installation (for example rotor hub) as well as the rotor blades.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wind power installation comprising:
at least one component to be monitored; and
a crack detection unit for detecting a crack in the component to be monitored, wherein the crack detection unit has at least one thread or fiber that is fastened on or in the component to be monitored, and a crack detector for detecting whether the thread or fiber is cracked.

2. The wind power installation according to claim 1 and further comprising:
a control unit for controlling the operation of the wind power installation, wherein the crack detector is coupled to the control unit and the control unit is adapted to change an operating parameter of the wind power installation when the crack detector has detected a crack in the thread or fiber.

3. The wind power installation according to claim 1 wherein the thread or fiber is electrically conducting or light-conducting.

4. The wind power installation according to claim 3 wherein the thread is in the form of an optical wave guide or an electric conductor.

5. The wind power installation according to claim 4 wherein the fiber is in the form of a glass fiber or a carbon fiber.

6. The wind power installation according to claim 1 wherein the thread or the fiber is glued at spaced apart points or across a length of the thread or fiber to the surface of the component to be monitored.

7. A method of monitoring components of a wind power installation, the method comprising:
fastening at least one thread or at least one fiber to one or more surfaces of the component to be monitored; and
detecting whether the thread or fiber is cracked.

8. The method according to claim 7 and further comprising:
in response to a crack in the thread or fiber being detected, adjusting an operation of the wind power installation.

9. (canceled)

10. The wind power installation according to claim 1 wherein the crack detector is configured to sense an electrical parameter of the thread or fiber.

11. The wind power installation according to claim 1 wherein the crack detector is configured to sense an optical signal received from the thread or fiber.

12. A wind power installation comprising:
a pylon;
a plurality of rotor blades; and
crack detection unit, the crack detection unit including threads or fibers secured to a surface of at least one of the rotor blades and the pylon, the crack detection unit further including a crack detector configured to receive an optical or electrical signal from the thread or fiber, and in response to receiving the optical or electrical signal the crack detector is configured to determine whether the threads or fibers are cracked.

13. The wind power installation according to claim 12 wherein at least some of the threads and fibers are secured to an outer surface of the blades.

14. The wind power installation according to claim 12 wherein the threads and fibers are secured to an inner surface of the pylon.

15. The wind power installation according to claim 12 further comprising a control unit coupled to the crack detector, the crack detector configured to send a signal to the control unit indicating that the threads or fibers are cracked, the control unit being configured to adjust an operation of the wind power installation in response to receiving the signal indicating that the threads or fibers are cracked.

16. The wind power installation according to claim 12 wherein the threads or fibers are one of light conductors, optical waveguides, electric conductors, glass fibers, and carbon fibers.

17. The wind power installation according to claim 1 wherein the crack detection unit has at least one thread or fiber that is fastened to a surface of the component to be monitored.

18. The wind power installation according to claim 1 wherein the crack detection unit has at least one thread or fiber that is embedded in the component to be monitored.
